(19) United States
(12) Patent Application Publication
(10) Pub. No.: US 2025/0251719 A1
(43) Pub. Date: Aug. 7, 2025

(54) MANUFACTURING SYSTEM FOR ELECTRONIC DEVICE

(71) Applicant: Innolux Corporation, Miaoli County (TW)

(72) Inventors: Meng-Xue Wu, Miaoli County (TW); Yung-Hua Chang, Miaoli County (TW); Wen-Jie Tsai, Miaoli County (TW)

(73) Assignee: Innolux Corporation, Miaoli County (TW)

(21) Appl. No.: 19/008,664

(22) Filed: Jan. 3, 2025

(30) Foreign Application Priority Data
Feb. 1, 2024 (CN) 202410144566.5

(51) Int. Cl. G05B 19/418

(52) U.S. Cl. CPC G05B 19/41865

(57) ABSTRACT

A manufacturing system for an electronic device is provided. The manufacturing system includes a manufacturing equipment, a calculation unit, and a comparison unit. The manufacturing equipment provides a previous data string and a real-time data string. The calculation unit receives the previous data string and outputs an upper control limit value and a lower control limit value accordingly. The comparison unit generates an exponentially weighted moving average (EWMA) slope value based on the real-time data string, and compares the EWMA slope value with the upper control limit value and the lower control limit value to generate a comparison result.

### CROSS-REFERENCE TO RELATED APPLICATION

This application claims the priority benefit of China application serial no. 202410144566.5, filed on Feb. 1, 2024. The entirety of the above-mentioned patent application is hereby incorporated by reference herein and made a part of this specification.

### BACKGROUND

### Technical Field

The disclosure relates to a manufacturing system, and in particular to a manufacturing system for an electronic device and/or an electronic element.

### Description of Related Art

A manufacturing system may include a manufacturing equipment. When the manufacturing equipment is operated to manufacture an electronic device and/or an electronic element, the data values of the process parameters of the manufacturing equipment need to be grasped at any time and the data values need to be controlled. When the data values approach or exceed a control limit value, the manufacturing system generates a warning message to reduce the production of electronic devices and/or electronic elements with abnormal specifications by the manufacturing equipment. However, when the data values of the process parameters of the manufacturing equipment are gradually increased or decreased over time and show trending cyclic fluctuations, fixed control limit values are not applicable to control the manufacturing equipment. Therefore, how to provide appropriate management methods and manufacturing systems is one of the research focuses of those skilled in the art.

### SUMMARY

The disclosure is directed to a manufacturing system for an electronic device that may control data values that exhibit trending cyclic fluctuations.

According to an embodiment of the disclosure, a manufacturing system includes a manufacturing equipment, a calculation unit, and a comparison unit. The manufacturing equipment provides a previous data string and a real-time data string. The calculation unit receives the previous data string and outputs an upper control limit value and a lower control limit value accordingly. The comparison unit generates an exponentially weighted moving average (EWMA) slope value based on the real-time data string, and compares the EWMA slope value with the upper control limit value and the lower control limit value to generate a comparison result.

Based on the above, the manufacturing system may calculate the EWMA slope value of the data values and compare the EWMA slope value with the upper control limit value and the lower control limit value to generate the comparison result. In this way, the manufacturing system may control data values having cyclic fluctuations.

### BRIEF DESCRIPTION OF THE DRAWINGS

FIG. 1 is a schematic diagram of a manufacturing system shown according to an embodiment of the disclosure.

FIG. 2 is a flowchart of a management method shown according to an embodiment of the disclosure.

FIG. 3 is a schematic diagram of data strings and data values shown according to an embodiment of the disclosure.

FIG. 4 is a flowchart of a management method shown according to an embodiment of the disclosure.

FIG. 5 is a flowchart of a management method shown according to an embodiment of the disclosure.

FIG. 6 is a schematic diagram of EWMA slope values shown according to an embodiment of the disclosure.

FIG. 7 is a schematic diagram of data values in a single period shown according to an embodiment of the disclosure.

### DESCRIPTION OF THE EMBODIMENTS

The disclosure may be understood by referring to the following detailed description taken in conjunction with the accompanying drawings as described below. It should be noted that for the object of clarity and ease of understanding for the reader, each drawing of the disclosure illustrates a portion of an electronic device, and certain elements in each drawing may not be drawn to scale. In addition, the number and size of each device depicted in the drawings are illustrative and not intended to limit the scope of the disclosure.

Certain terms are used throughout the description and the following claims to refer to specific elements. As those skilled in the art will understand, electronic equipment manufacturers may refer to elements by different names. This document does not intend to differentiate between elements that have different names rather than different functions. In the following description and in the claims, the terms “containing”, “including”, and “having” are used in an open-ended manner, and should therefore be construed to mean “containing but not limited to . . . ” Accordingly, when the terms “containing”, “including”, and/or “having” are used in the description of the disclosure, it will be indicated that there are corresponding features, regions, steps, operations, and/or elements, but not limited to there being one or a plurality of corresponding features, regions, steps, operations, and/or members.

It should be understood that, when an element is referred to as being “coupled to”, “electrically connected to”, or “conducted to” another element, the element may be directly electrically connected to another element and an electrical connection may be established directly, or there may be an intermediate element between these elements for relaying an electrical connection (indirect electrical connection). In contrast, when an element is referred to as being “directly coupled to,” “directly electrically connected to”, or “directly connected to” another element, there are no intervening members present.

Although terms such as first, second, third, etc. may be used to describe various constituent elements, such constituent elements are not limited by these terms. The terms are used to distinguish a constituent element from other constituent elements in the specification. The claims may not use the same terms, but may use the terms first, second, third etc. with respect to the desired order of the elements. Therefore, in the following description, a first constituent element may be a second constituent element in the claims.

An electronic device of the disclosure may include a display device, an antenna device, a sensing device, a light-emitting device, a touch display, a curved display, or a free shape display, but not limited to. The electronic device may include a bendable or flexible electronic device. The electronic device may, for example, include an electronic element, liquid crystal, light-emitting diode, quantum dot (QD), fluorescence, phosphor, other suitable display media, or a combination of the above materials, but the disclosure is not limited thereto. The electronic element may include a passive element and an active element, such as a capacitor, a resistor, an inductor, a diode, a transistor, and the like. The diode may include a light-emitting diode or a photodiode. The light-emitting diode may include, for example, an organic light-emitting diode (OLED), a mini LED, a micro LED, or a quantum dot LED (may include QLED or QDLED), or other suitable materials, or a combination of the above, but the disclosure is not limited thereto. The display device may include, for example, a tiling display device, but the disclosure is not limited thereto. The antenna device may be, for example, a liquid-crystal antenna, but the disclosure is not limited thereto. The antenna device may include, for example, an antenna tiling device, but the disclosure is not limited thereto. It should be noted that the electronic device may be any arrangement and combination of the above, but the disclosure is not limited thereto. In addition, the shape of the electronic device may be rectangular, circular, polygonal, a shape having curved edges, or other suitable shapes. The electronic device may have a peripheral system such as a driving system, a control system, a light source system, etc. to support a display device, an antenna device, or a tiling device, but the disclosure is not limited thereto. The sensing device may include a camera, an infrared sensor, or a fingerprint sensor, etc., but the disclosure is not limited thereto. In some embodiments, the sensing device may further include a flashlight, an infrared (IR) light source, other sensors, electronic elements, or a combination thereof, but the disclosure is not limited thereto.

It should be noted that technical features in different embodiments described below may be replaced, reorganized, or mixed with each other to form another embodiment without departing from the spirit of the disclosure.

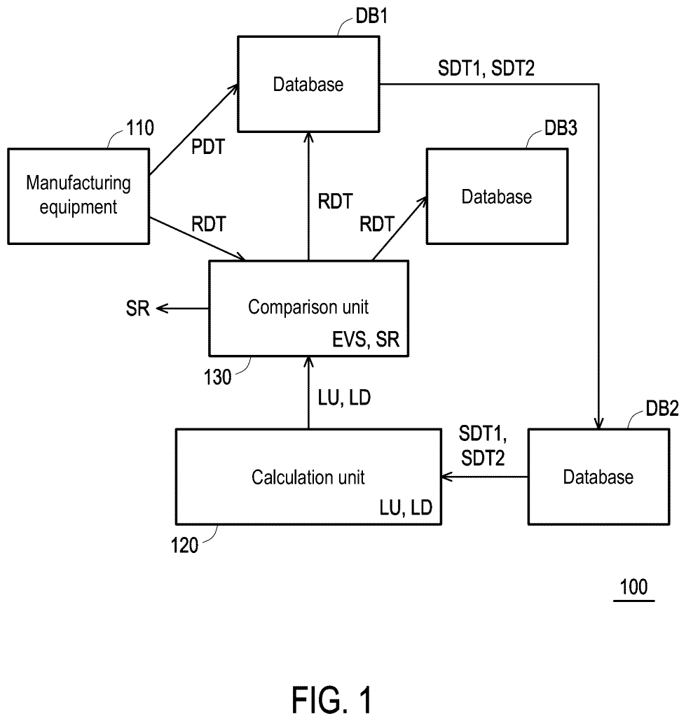

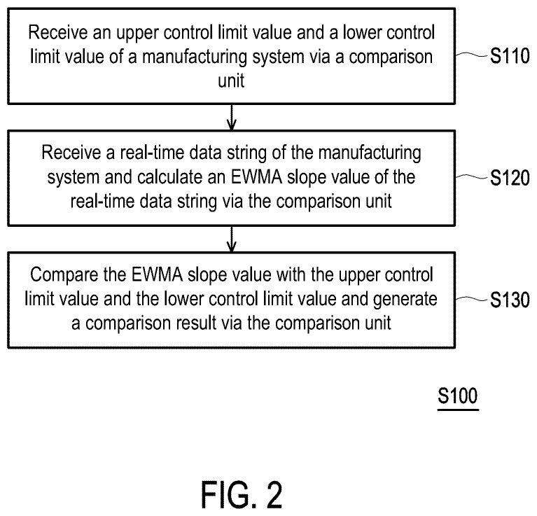

Please refer to FIG. 1 and FIG. 2 simultaneously. FIG. 1 is a schematic diagram of a manufacturing system shown according to an embodiment of the disclosure. FIG. 2 is a flowchart of a management method shown according to an embodiment of the disclosure. In the present embodiment, a manufacturing system 100 includes a manufacturing equipment 110, a calculation unit 120, and a comparison unit 130. The manufacturing system 100 may further include databases DB1, DB2, and DB3 (but the disclosure is not limited thereto) to store process parameter data needed by the manufacturing system 100, including data strings such as historical parameter data (i.e., a previous data string PDT) and real-time parameter data (i.e., a real-time data string RDT).

In the present embodiment, a management method S100 is applicable to the manufacturing system 100. The management method S100 includes steps S110 to S130. In the present embodiment, the manufacturing equipment 110 may provide the previous data string (i.e., historical parameter data) PDT generated in the past production of the electronic device to the calculation unit 120 to establish the upper control limit value LU and the lower control limit value LD of the manufacturing system 100. The previous data string PDT may include a first data string SDT1 and a second data string SDT2. The calculation unit 120 receives the first data string SDT1 and the second data string SDT2 of the previous data string PDT, and establishes the upper control limit value LU and the lower control limit value LD according to the first data string SDT1 and the second data string SDT2.

In another embodiment, the previous data string PDT may also be provided to the database DB1 first for use by the calculation unit 120, or the database DB1 may transmit the first data string SDT1 and the second data string SDT2 in the previous data string PDT to the database DB2 for use by the calculation unit 120.

In the manufacturing system 100 of the present embodiment, the comparison unit 130 is coupled to the calculation unit 120 and the manufacturing equipment 110. In step S110 of the management method S100, the comparison unit 130 receives the upper control limit value LU and the lower control limit value LD. In step S120, the comparison unit 130 calculates an exponentially weighted moving average (EWMA) slope value EVS of the real-time data string (i.e., real-time parameter data) RDT from the manufacturing equipment 110. In step S130, the comparison unit 130 compares the EWMA slope value EVS of the real-time data string RDT with the upper control limit value LU and the lower control limit value LD and generates a comparison result SR.

It should be mentioned here that, the manufacturing system 100 may calculate the EWMA slope value EVS of the real-time data string RDT, and compare the EWMA slope value EVS with the upper control limit value LU and the lower control limit value LD to generate the comparison result SR. In this way, the comparison unit 130 may control the real-time data string RDT having cyclic fluctuations.

In the present embodiment, when the EWMA slope value EVS of the real-time data string RDT is greater than the upper control limit value LU or less than the lower control limit value LD, it means that at this time, the real-time data string RDT does not meet the specifications of the manufacturing parameters, and an electronic device with poor quality is readily produced. Therefore, the comparison unit 130 may output the comparison result SR. In addition, the comparison unit 130 may report the real-time data string RDT that does not meet the manufacturing parameter specifications to the database DB3. The comparison result SR representing that the manufacturing parameter specifications are not met may be a warning light, warning text, or warning sound, but the disclosure is not limited thereto.

Moreover, when the EWMA slope value EVS of the real-time data sequence RDT is less than or equal to the upper control limit value LU and greater than or equal to the lower control limit value LD, it means that the real-time data string RDT at this time meets the specifications of the manufacturing parameters. Therefore, the comparison unit 130 may not output the comparison result SR. In other words, in an embodiment, the comparison unit 130 may output the comparison result SR when the real-time data string RDT does not meet the specifications of the manufacturing parameters. In another embodiment, the comparison unit 130 may output the comparison result SR both when the real-time data string RDT does not meet the specifications of the manufacturing parameters and when the real-time data string RDT meets the specifications of the manufacturing parameters, and whether the real-time data string RDT meets the specifications of the manufacturing parameters is distinguished via the content of the comparison result SR. In addition, the comparison unit 130 may return the real-time data string RDT meeting the manufacturing parameter specifications to the database DB1.

In the present embodiment, the previous data string PDT and the real-time data string RDT may be, for example, monitored values such as flow values, temperature values, pressure values, etc. of the fluid adopted in the manufacturing equipment 110, but the disclosure is not limited thereto. In the present embodiment, the calculation unit 120 and the comparison unit 130 may each be implemented by a device, but the disclosure is not limited thereto.

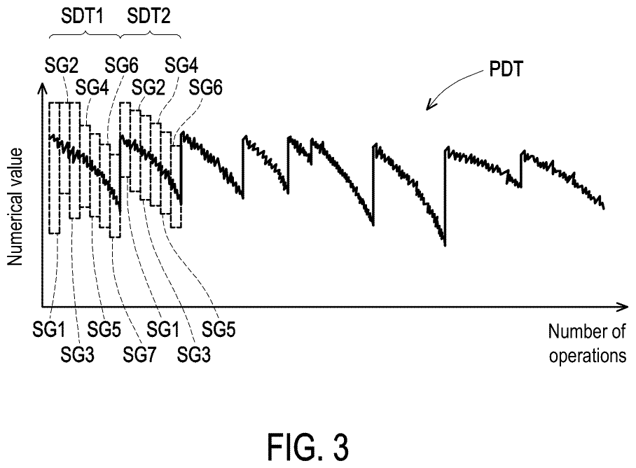

Please refer to FIG. 1 and FIG. 3 simultaneously. FIG. 3 is a schematic diagram of the previous data string PDT shown according to an embodiment of the disclosure. In the present embodiment, FIG. 3 shows the first data string SDT1 and the second data string SDT2 corresponding to different time intervals. Both the first data string SDT1 and the second data string SDT2 exhibit periodic cyclic fluctuations. Therefore, both the first data string SDT1 and the second data string SDT2 may be used as comparison models.

For example, the previous data string PDT may be the flow value of the solution through the filter element of the manufacturing equipment 110. Over time, when the solution passes through the filter element of the manufacturing equipment 110, the filter element is clogged. Therefore, as the use time of the filter element is increased, the degree of clogging of the filter element is more significant, and therefore the flow value is decreased with time of use. Therefore, when the flow valve of the manufacturing equipment 110 is adjusted to increase the flow value or the filter element is replaced, the flow value is greater, and at this time, a new period begins. In other words, the previous data string PDT before the flow valve of the manufacturing equipment 110 is adjusted to increase the flow value or the filter element is replaced may be divided into the first data string SDT1, and the previous data string PDT afterward may be divided into the second data string SDT2.

In the present embodiment, the upper control limit value LU and the lower control limit value LD may be obtained via the calculation unit 120.

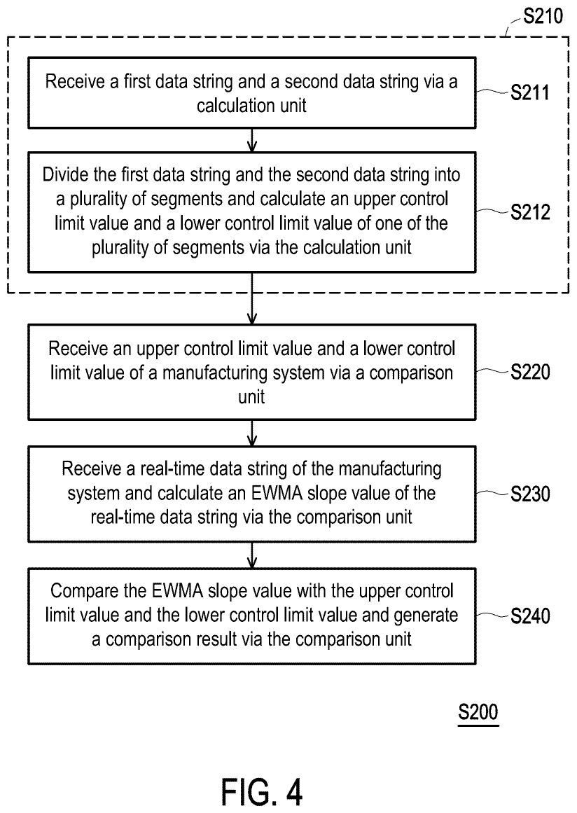

Please refer to FIG. 1, FIG. 3, and FIG. 4 at the same time. FIG. 4 is a flowchart of a management method shown according to an embodiment of the disclosure. In the present embodiment, a management method S200 includes a system control establishment method S210 and steps S220 to S240. In the present embodiment, the calculation unit 120 executes the system control establishment method S210 to obtain the upper control limit value LU and the lower control limit value LD. The system control establishment method S210 includes steps S211 and S212. In step S211, the calculation unit 120 receives the first data string SDT1 and the second data string SDT2. In step S212, the calculation unit 120 independently divides the first data string SDT1 and the second data string SDT2 into a plurality of segments, and calculates the upper control limit value LU and the lower control limit value LD of one of the plurality of segments.

In the present embodiment, the calculation unit 120 outputs the upper control limit value LU with reference to the cumulative fitted regression line slope of the one of the plurality of segments of the first data string SDT1 and the second data string SDT2 and the segment before the one of the segments and the average standard deviation value of each of the plurality of segments. The calculation unit 120 outputs the lower control limit value LD with reference to the cumulative fitted regression line slope of the one of the plurality of segments of the first data string SDT1 and the second data string SDT2 and the segment before the one of the segments and the average standard deviation value of each of the plurality of segments.

To further describe the implementation example of step S212, please refer to Table 1. Table 1 is a generation table of the upper control limit value LU and the lower control limit value LD shown according to an embodiment of the disclosure. In the present embodiment, the data amount of the first data string SDT1 is greater than the data amount of the second data string SDT2. Therefore, the first data string SDT1 may be divided into segments SG1 to SG7, and the second data string SDT2 may be divided into segments SG1 to SG6.

TABLE 1

| | SDT1 | SDT2 | SAV | SIG | LU | LD |
|---|---|---|---|---|---|---|
| SG1 | S1_1 | S2_1 | SA1 | SIG1 | SA1 + 3 × SIGA | SA1 − 3 × SIGA |
| SG2 | S1_2 | S2_2 | SA2 | SIG2 | SA2 + 3 × SIGA | SA2 − 3 × SIGA |
| SG3 | S1_3 | S2_3 | SA3 | SIG3 | SA3 + 3 × SIGA | SA3 − 3 × SIGA |
| SG4 | S1_4 | S2_4 | SA4 | SIG4 | SA4 + 3 × SIGA | SA4 − 3 × SIGA |
| SG5 | S1_5 | S2_5 | SA5 | SIG5 | SA5 + 3 × SIGA | SA5 − 3 × SIGA |
| SG6 | S1_6 | S2_6 | SA6 | SIG6 | SA6 + 3 × SIGA | SA6 − 3 × SIGA |
| SG7 | S1_7 | | SA7 | | SA7 + 3 × SIGA | SA7 − 3 × SIGA |
| | | | | SIGA | | |

The number of segments of the first data string SDT1 and the number of segments of the second data string SDT2 may be determined by formula (1). In formula (1), “SG” is the number of segments. “B” is a constant. “N” is the number of operations or time of the manufacturing equipment 110. For example, “B” equals “2.5”. “N” equals “10000”. Therefore, the number of segments is equal to “10”. For example, “B” equals “2”. “N” equals “10000”. Therefore, the number of segments is equal to “8”. For example, “B” equals “2.5”. “N” equals “1000”. Therefore, based on rounding off from 4 to 5, the number of segments equals “8”. Based on unconditional rounding out, the number of segments is equal to “7”.

$$S G = B \times log ( N ) \qquad formula ( 1 )$$

After the number of segments is obtained, the number of operations of the manufacturing equipment 110 in each segment may be determined by formula (2).

$$PC = N / SG \qquad formula ( 2 )$$

In formula (2), “PC” is the number of operations of the manufacturing equipment 110 in each segment.

In the present embodiment, the greater the number of segments, the cyclic fluctuation trend of each segment may approach linearity. A larger number of segments facilitates the monitoring and/or control of non-linear trends in a single period.

In the present embodiment, the calculation unit 120 calculates the cumulative fitted regression line slope S1_1 of the segment SG1 of the first data string SDT1, the overall cumulative fitted regression line slope S1_2 of the segment SG1 to the segment SG2 of the first data string SDT1, the overall cumulative fitted regression line slope S1_3 of the segment SG1 to the segment SG3 (including segment 2) of the first data string SDT1, the overall cumulative fitted regression line slope S1_4 of the segment SG1 to the segment SG4 of the first data string SDT1, the overall cumulative fitted regression line slope S1_5 of the segment SG1 to the segment SG5 of the first data string SDT1, the overall cumulative fitted regression line slope S1_6 of the segment SG1 to the segment SG6 of the first data string SDT1, and the overall cumulative fitted regression line slope S1_7 of the segment SG1 to the segment SG7 of the first data string SDT1.

Similarly, the calculation unit 120 calculates the cumulative fitted regression line slope S2_1 of the segment SG1 of the second data string SDT2, the overall cumulative fitted regression line slope S2_2 of the segment SG1 to the segment SG2 of the second data string SDT2, the overall cumulative fitted regression line slope S2_3 of the segment SG1 to the segment SG3 of the second data string SDT2, the overall cumulative fitted regression line slope S2_4 of the segment SG1 to the segment SG4 of the second data string SDT2, the overall cumulative fitted regression line slope S2_5 of the segment SG1 to the segment SG5 of the second data string SDT2, and the overall cumulative fitted regression line slope S2_6 of the segment SG1 to the segment SG6 of the second data string SDT2.

The calculation unit 120 calculates the average value SA1 and the standard deviation value SIG1 of the cumulative fitted regression line slope S1_1 of the segment SG1 of the first data string SDT1 and the cumulative fitted regression line slope S2_1 of the segment SG1 of the second data string SDT2. Similarly, the calculation unit 120 calculates the average value SA2 and the standard deviation value SIG2 of the cumulative fitted regression line slope S1_2 of the first data string SDT1 and the cumulative fitted regression line slope S2_2 of the second data string SDT2, and so on. Therefore, the calculation unit 120 calculates the average values SA1 to SA7 and the standard deviation values SIG1 to SIG6.

The calculation unit 120 calculates the average standard deviation value SIGA of the standard deviation values SIG1 to SIG6.

In the present embodiment, the calculation unit 120 adds 3 times the average standard deviation value SIGA to the average values SA1 to SA7 of the cumulative fitted regression line slopes corresponding to the segments SG1 to SG7 respectively to output the upper control limit values LU corresponding to the segments SG1 to SG7. The calculation unit 120 subtracts 3 times the average standard deviation value SIGA from the average values SA1 to SA7 of the cumulative fitted regression line slopes corresponding to the segments SG1 to SG7 respectively to output the lower control limit values LD corresponding to the segments SG1 to SG7, but the disclosure is not limited thereto. In other embodiments, the calculation unit 120 adds N times the average standard deviation value SIGA to the average values SA1 to SA7 of the cumulative fitted regression line slopes respectively to output the upper control limit value LU. The calculation unit 120 subtracts N times the average standard deviation value SIGA from the average values SA1 to SA7 of the cumulative fitted regression line slopes respectively to output the lower control limit value LD. When N is greater than 3, the control procedures for the manufacturing equipment 110 may be relaxed. Similarly, when N is less than 3, the control procedures for the manufacturing equipment 110 may be tightened.

For example, the calculation unit 120 adds 3 times the average standard deviation value SIGA to the average value SA1 (i.e., LU=SA1+3×SIGA) to output the upper control limit value LU corresponding to the segment SG1. The calculation unit 120 adds 3 times the average standard deviation value SIGA to the average value SA2 (i.e., LU=SA2+3×SIGA) to output the upper control limit value LU corresponding to the segment SG2, and so on.

For example, the calculation unit 120 subtracts 3 times the average standard deviation value SIGA from the average value SA1 (i.e., LD=SA1−3×SIGA) to output the lower control limit value LD corresponding to the segment SG1. The calculation unit 120 subtracts 3 times the average standard deviation value SIGA from the average value SA2 (i.e., LD=SA2−3×SIGA) to output the lower control limit value LD corresponding to the segment SG2, and so on.

It should be noted that in the present embodiment, the calculation unit 120 establishes the slope specification for the real-time data string RDT based on the fluctuations of the previous data string PDT. The center value of the slope specification is determined by the average values SA1 to SA7 of the segments SG1 to SG7 of the previous data string PDT. In addition, the upper control limit value LU and the lower control limit value LD of the slope specification are determined by the average standard deviation value SIGA. Therefore, the slope difference between the upper control limit value LU and the lower control limit value LD may be fixed.

In the present embodiment, steps S220 to S240 are similar to steps S110 to S130 in FIG. 2 and are therefore not repeated here.

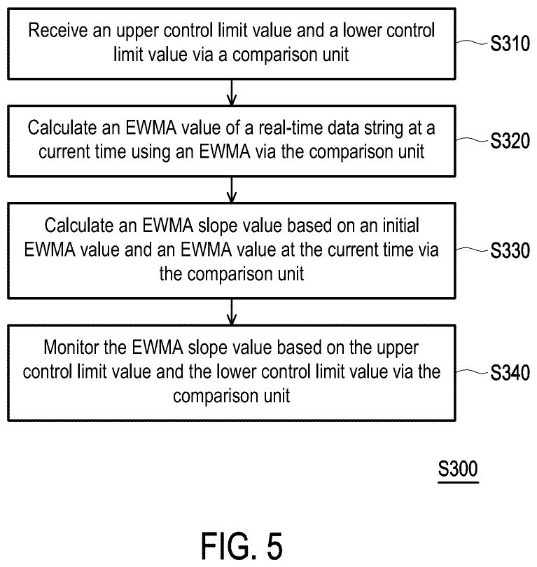

Please refer to FIG. 1 and FIG. 5 at the same time. FIG. 5 is a flowchart of a management method shown according to an embodiment of the disclosure. In the present embodiment, a management method S300 includes steps S310 to S340. In step S310, the comparison unit 130 receives the upper control limit value LU and the lower control limit value LD. In step S320, the comparison unit 130 calculates the EWMA value of the real-time data string RDT using EWMA.

For example, the comparison device 130 may obtain the EWMA value according to formula (3).

$${C}_{k} = λ \times {A}_{( k - 1 )} + ( 1 - λ ) \times {C}_{( k - 1 )} \qquad formula ( 3 )$$

In formula (3), “Cₖ” is the EWMA value of the real-time data string RDT at the current time (i.e., the k-th moment). “λ” is the weight value. “Cₖ₋₁” is the EWMA value of the real-time data string RDT at the previous time (i.e., the (k−1)th moment). “Aₖ₋₁” is the actual value of the real-time data string RDT at the previous time (i.e., the (k−1)th moment).

In the present embodiment, the weight value/may be between “0.05” and “1”. The weight value/may be adjusted. For example, when the weight value λ is less, the curve of the EWMA value is smoother. When the weight value λ is greater, the curve of the EWMA value is rougher. In some embodiments, the weight value λ may be between “0.85” and “0.95”. The disclosure is not limited to the range of the weight value λ.

In step S330, the comparison unit 130 calculates the EWMA slope value EVS based on the initial EWMA value and the EWMA value of the real-time data string RDT at the current time (i.e., the k-th moment).

For example, the comparison unit 130 may calculate the EWMA slope value EVS of the current period according to formula (4).

$$EVS = ( {C}_{k} - {C}_{1} ) / k \qquad formula ( 4 )$$

In formula (4), “C1” is the initial EWMA value of the current period. The initial EWMA value “C₁” is approximately equal to the initial actual value “A₀”.

It should be mentioned here that, in steps S320 and 330, the comparison unit 130 needs the actual value of the previous time (i.e., “Aₖ₋₁”), the EWMA value of the real-time data string RDT of the previous time (i.e., “Cₖ₋₁”), the EWMA value of the current time (i.e., “Cₖ”), and the initial EWMA value of the current period (i.e., “C₁”) to calculate the real-time EWMA slope value EVS of the current period. Therefore, the amount of data needed to be stored by the comparison unit 130 may be reduced. Therefore, the computing resources needed by the comparison unit 130 may also be reduced to save costs and/or energy consumption.

In step S340, the comparison unit 130 monitors the EWMA slope value EVS based on the upper control limit value LU and the lower control limit value LD. The comparison unit 130 may compare the EWMA slope value EVS of the real-time data string RDT with the upper control limit value LU and the lower control limit value LD and generate the comparison result SR in step S340.

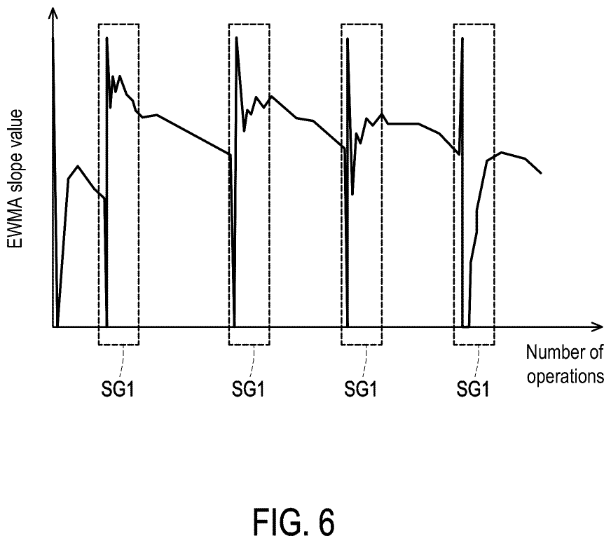

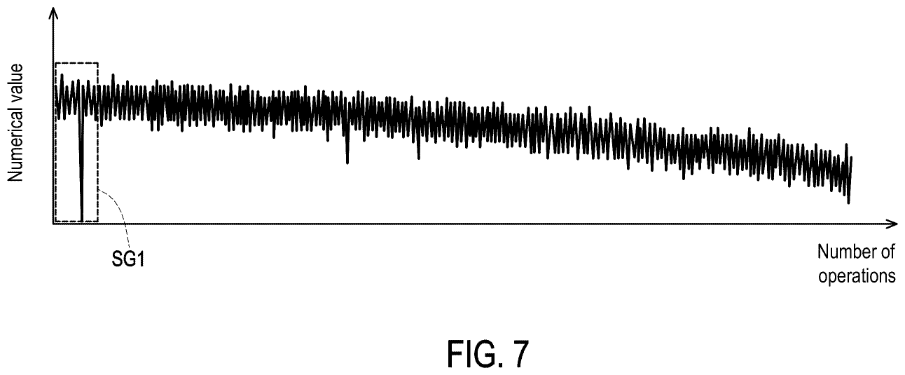

Please refer to FIG. 1, FIG. 6, and FIG. 7 at the same time. FIG. 6 is a schematic diagram of an EWMA slope value shown according to an embodiment of the disclosure. FIG. 7 is a schematic diagram of data values in a single period shown according to an embodiment of the disclosure. In the present embodiment, FIG. 6 shows EWMA slope values of different periods. It should be noted that based on formula (4), since the “k” value of the initial segment (e.g., the segment SG1) of each period is less, the EWMA slope value of the initial segment of each period has greater fluctuation. The initial segment may be viewed as an unstable period in each period. Therefore, in step S340, the comparison unit 130 may not monitor the EWMA slope value EVS of the initial segment of each period based on the upper control limit value LU and the lower control limit value LD.

An embodiment of the present application also provides a computer-readable storage medium on which a computer program is stored. The computer program may be used to make the computer execute any of the management methods of any of the above embodiments.

An embodiment of the application also provides a computer non-volatile readable storage medium. The storage medium stores one or a plurality of program modules. When one or a plurality of program modules are used on an equipment, the equipment may execute the instructions included in any of the steps of any one of the above embodiments.

The computer-readable storage medium may be, for example (but not limited to) an electronic, magnetic, optical, electromagnetic, infrared, or semiconductor device or apparatus, or any combination of the above. More specific examples of computer-readable storage medium may include, but are not limited to, portable computer disks, hard disks, random-access memory (RAM), read-only memory (ROM), erasable programmable read-only memory (EPROM), optical fiber, CD-ROM, optical storage device, magnetic storage device, or any suitable combination of the above.

Based on the above, the manufacturing system calculates the EWMA slope value of the data value and compares the EWMA slope value with the upper control limit value and the lower control limit value to generate the comparison result. In this way, the manufacturing system may control data values having cyclic fluctuations. Furthermore, the first data string is divided into a plurality of segments. The second data string is divided into a plurality of segments. The greater the number of segments, the cyclic fluctuation trend of each segment may approach linearity. A larger number of segments facilitates the monitoring and control of non-linear trends in a single period.

Lastly, it should be mentioned that: each of the above embodiments is used to describe the technical solutions of the disclosure and is not intended to limit the disclosure; and although the disclosure is described in detail via each of the above embodiments, those having ordinary skill in the art should understand that: modifications may still be made to the technical solutions recited in each of the above embodiments, or portions or all of the technical features thereof may be replaced to achieve the same or similar results; the modifications or replacements do not make the nature of corresponding technical solutions depart from the scope of the technical solutions of each of the embodiments of the disclosure.

What is claimed is:

1. A manufacturing system for an electronic device, comprising:
a manufacturing equipment providing a previous data string and a real-time data string;
a calculation unit receiving the previous data string and outputting an upper control limit value and a lower control limit value accordingly; and
a comparison unit generating an exponentially weighted moving average (EWMA) slope value based on the real-time data string, and comparing the EWMA slope value with the upper control limit value and the lower control limit value to generate a comparison result.

2. The manufacturing system of claim 1, wherein when the EWMA slope value is greater than the upper control limit value or less than the lower control limit value, the comparison unit generates a warning result.

3. The manufacturing system of claim 1, wherein when the EWMA slope value is less than or equal to the upper control limit value and greater than the lower control limit value, the comparison unit does not generate a warning result.

4. The manufacturing system of claim 1, wherein the previous data string and the real-time data string are flow values of a fluid adopted by the manufacturing equipment respectively.

5. The manufacturing system of claim 1, wherein the previous data string and the real-time data string are temperature values of a fluid adopted by the manufacturing equipment respectively.

6. The manufacturing system of claim 1, wherein the previous data string and the real-time data string are pressure values of a fluid adopted by the manufacturing equipment respectively.

7. The manufacturing system of claim 1, wherein the calculation unit obtains the upper control limit value and the lower control limit value via a system control establishment method.

8. The manufacturing system of claim 7, wherein in the system control establishment method, the calculation unit establishes a slope specification for the real-time data string based on a fluctuation of the previous data string.

9. The manufacturing system of claim 8, wherein a center value of the slope specification is determined by an average value of a plurality of segments of the previous data string.

10. The manufacturing system of claim 8, wherein the upper control limit value and the lower control limit value of the slope specification are determined by an average standard deviation value of the plurality of segments.

11. The manufacturing system of claim 7, wherein in the system control establishment method:
the calculation unit receives a first data string and a second data string; and
the calculation unit independently divides the first data string and the second data string into a plurality of segments and calculates the upper control limit value and the lower control limit value of one of the plurality of segments.

12. The manufacturing system of claim 11, wherein the calculation unit outputs the upper control limit value with reference to a cumulative fitted regression line slope of the one of the plurality of segments and a segment before the one segment and an average standard deviation value of each of the plurality of segments.

13. The manufacturing system of claim 12, wherein the calculation unit adds 3 times the average standard deviation value from an average value of the cumulative fitted regression line slope to output the upper control limit value.

14. The manufacturing system of claim 12, wherein:
the calculation unit calculates a first average value and a first standard deviation value of a cumulative fitted regression line slope of a first segment of the first data string and a cumulative fitted regression line slope of a first segment of the second data string;
the calculation unit calculates a second average value and a second standard deviation value of a cumulative fitted regression line slope of a second segment of the first data string and a cumulative fitted regression line slope of a second segment of the second data string; and
the calculation unit calculates the average standard deviation value of the first standard deviation value and the second standard deviation value.

15. The manufacturing system of claim 14, wherein the calculation unit adds 3 times the average standard deviation value based on the first average value to output an upper control limit value corresponding to the first segment.

16. The manufacturing system of claim 11, wherein the calculation unit outputs the lower control limit value with reference to a cumulative fitted regression line slope of the one of the plurality of segments and a segment before the one segment and an average standard deviation value of each of the plurality of segments.

17. The manufacturing system of claim 16, wherein the calculation unit subtracts 3 times the average standard deviation value from an average value of the cumulative fitted regression line slope to output the lower control limit value.

18. The manufacturing system of claim 11, wherein the first data string and the second data string exhibit a periodic cyclic fluctuation.

19. The manufacturing system of claim 11, wherein the comparison unit monitors the EWMA slope values of segments other than an initial segment of the real-time data string based on the upper control limit value and the lower control limit value.

20. The manufacturing system of claim 11, wherein the plurality of segments are determined based on one of a number of operations and a time of the manufacturing equipment.
